(19) United States
(12) Patent Application Publication
(10) Pub. No.: US 2012/0024280 A1
(43) Pub. Date: Feb. 2, 2012

(54) Pre-Assembled Barbecue Grill

(76) Inventors: David Laporta, Matawan, NJ (US); Tung-Sheng Kuo, Hsin Chu City (TW)

(21) Appl. No.: 12/847,693

(22) Filed: Jul. 30, 2010

(51) Int. Cl. A47J 37/00

(52) U.S. Cl. 126/25 R

(57) ABSTRACT

A partially assembled grill comprises a frame unit having a bottom and two sides, one side mounted to pivot on one end of the bottom so that it is folded against the bottom, and the other side mounted to pivot on the other end of the bottom and positioned generally perpendicular to the bottom, to form a partially folded frame, and a grill casing, wherein the partially folded frame unit encloses the grill casing on two adjacent perpendicular surfaces.

### FIELD OF THE INVENTION

The present invention relates to barbecue grills, and more particularly to barbecue grills that are partially assembled when shipped and sold and can be assembled quickly and easily by a consumer.

### BACKGROUND OF THE INVENTION

Most barbecue grills are shipped and sold in an entirely unassembled state, presumably because the manufacturer does not want to invest cost in making any assembly of the product and because any partial assembly would increase the size of the product and make it more fragile. However, the consumer must assemble the product or pay an extra charge to the retailer to assemble it, and in the latter case must get the assembled product home. Typically, assembly instructions are confusing or complex, assembly takes a long time, and parts may be missing. Some parts or fasteners can be not incorporated, and may create an unsafe condition for the grill, the top case of which is usually quite heavy and could fall during use when an ongoing fire poses a significant safety risk.

The above factors weigh in a consumers decision to even purchase the product in the first place. Attempts have been made to offer partially preassembled grills, but they are cumbersome and still require many assembly steps.

### SUMMARY OF THE INVENTION

The present invention provides a partially assembled grill which can be shipped in a box or container on the same order of size as a totally unassembled grill. According the invention, the partially assembled grill needs only a small number of assembly steps and few parts to minimize the burden on a consumer. The partially assembled grill has the potential for making sales to customers who have shied away from a grill purchase due to the complexity and time of assembly of prior grills.

Despite being partially assembled when shipped, the fully assembled grill is still strong and safe to operate, especially because the consumer has very few parts to put together and the risk of failing to use all of the intended parts with be minimized.

The present invention provides a partially assembled grill comprising a frame unit having a bottom and two sides, one side mounted to pivot on one end of the bottom so that it is folded against the bottom, and the other side mounted to pivot on the other end of the bottom and positioned generally perpendicular to the bottom, to form a partially folded frame, and a grill casing, wherein the partially folded frame unit encloses the grill casing on two adjacent perpendicular surfaces.

The present invention provides a partially assembled grill comprising a frame unit having a bottom and two sides, one side mounted to pivot on one end of the bottom so that it is folded against the bottom, and the other side mounted to pivot on the other end of the bottom and positioned generally perpendicular to the bottom, to form a partially folded frame, and a grill casing, wherein the partially folded frame unit encloses the grill casing on two adjacent perpendicular surfaces, wherein the casing has four bottom corners, and wherein each of the four bottom corners includes a pre-mounted fastening element adapted to engage a pre-mounted mating fastening element on each of the four top corners on top of the frame.

The invention provides a partially assembled grill comprising a frame unit having a bottom and two sides, one side mounted to pivot on one end of the bottom so that it is folded against the bottom, and the other side mounted to pivot on the other end of the bottom and positioned generally perpendicular to the bottom, to faun a partially folded frame, and a grill casing, wherein the partially folded frame unit encloses the grill casing on two adjacent perpendicular surfaces, wherein the casing has four bottom corners, and wherein each of the four bottom corners includes a pre-mounted fastening element adapted to engage a pre-mounted mating fastening element on each of the four top corners on top of the frame, wherein the fastening element on the grill casing comprises a first type of element comprising a plate which defines a slotted opening and wherein the mating fastening element on the top of the frame unit comprises a first type of mating fastening element comprising a stud adapted to be received in the slotted opening, and a second type of fastening element comprising a latch and wherein the mating fastening element on the top of the frame unit comprises a second type of mating fastening element comprising a hook.

The invention provides a partially assembled grill comprising a frame unit having a bottom and two sides, one side mounted to pivot on one end of the bottom so that it is folded against the bottom, and the other side mounted to pivot on the other end of the bottom and positioned generally perpendicular to the bottom, to form a partially folded frame, and a grill casing, wherein the partially folded frame unit encloses the grill casing on two adjacent perpendicular surfaces, wherein the casing has four bottom corners, and wherein each of the four bottom corners includes a pre-mounted fastening element adapted to engage a pre-mounted mating fastening element on each of the four top corners on top of the frame, wherein the fastening element on the grill casing comprises a first type of element comprising a plate which defines a slotted opening and wherein the mating fastening element on the top of the frame unit comprises a first type of mating fastening element comprising a stud adapted to be received in the slotted opening, and a second type of fastening element comprising a latch and wherein the mating fastening element on the top of the frame unit comprises a second type of mating fastening element comprising a hook, wherein two of the first type of fastening elements and mating fastening elements are provided on the front corners of the casing and stand, and wherein two of the second type of fastening elements and mating fastening elements are provided on the back corners of the casing and stand.

The invention provides a method of packaging a partially assembled grill comprising locating a frame unit having a bottom and two sides, so that one side mounted to pivot on one end of the bottom so that it is folded against the bottom, and the other side is mounted to pivot on the other end of the bottom and positioned generally perpendicular to the bottom, to form a partially folded frame, and locating a grill casing so that the partially folded frame unit encloses the grill casing on two adjacent perpendicular surfaces.

### BRIEF DESCRIPTION OF THE DRAWINGS

FIG. 1 is a perspective view of a grill and stand folded in a packed configuration for shipping;

FIG. 2 is a perspective view like that of FIG. 1, but exploded;

FIG. 3 is a perspective view of the stand in its folded and shipped position;

FIG. 4 is a perspective view of the stand in a further stage of unfolded assembly than in FIG. 3;

FIG. 5 is a perspective view of the stand in a further stage of assembly than in FIG. 4;

FIG. 6 is a perspective view of the stand in a further stage of assembly than in FIG. 5;

FIG. 7 is a perspective view of the stand in a further stage of assembly than in FIG. 6;

FIG. 8 is a perspective view of the stand in a final stage of assembly;

FIG. 9 is a side view of the stand with the firebox casting unattached above;

FIG. 10 is a side view like that of FIG. 9 with the firebox on top of the stand but not yet in a final mounted position;

FIG. 11 is a side view like that of FIG. 10 with the firebox on top of the stand in a final position;

FIG. 12 is a side view like that of FIG. 11, with a locking latch in an unlatched position;

FIG. 13 is a side view like that of FIG. 12, with a locking latch in a latched position; and

FIGS. 14-18 show an alternate arrangement for a stand different from the arrangement in FIGS. 3-8.

### DESCRIPTION OF THE EMBODIMENT

An embodiment of the present invention will now be described, but the invention is not limited to this embodiment.

The present invention provides a partially assembled grill comprising a frame unit having a bottom and two sides, one side mounted to pivot on one end of the bottom so that it is folded against the bottom, and the other side mounted to pivot on the other end of the bottom and positioned generally perpendicular to the bottom, to form a partially folded frame, and a grill casing, wherein the partially folded frame unit encloses the grill casing on two adjacent perpendicular surfaces.

The frame unit comprises at least one side bar to connect the ends of the two sides away from the bottom. The frame of the side bar is connected at one of its ends to an end of one of the sides. The grill casing includes at least one fastening element pre-mounted to one of its bottom corners adapted to engage a pre-mounted fastening element on the top of the frame unit. The casing has four bottom corners, and wherein each of the four bottom corners includes a pre-mounted fastening element adapted to engage a pre-mounted mating fastening element on each of the four top corners on top of the frame. The fastening element on the grill casing comprises a first type of element comprising a plate which defines a slotted opening, and wherein the mating fastening element on the top of the frame unit comprises a first type of mating fastening element comprising a stud adapted to be received in the slotted opening The fastening element on the grill casing comprises a second type of fastening element comprising a latch and wherein the mating fastening element on the top of the frame unit comprises a second type of mating fastening element comprising a hook. Two of the first type of fastening elements and mating fastening elements are provided on the front corners of the casing and stand. Two of the second type of fastening elements and mating fastening elements are provided on the back corners of the casing and stand.

The present invention provides a partially assembled grill comprising a frame unit having a bottom and two sides, one side mounted to pivot on one end of the bottom so that it is folded against the bottom, and the other side mounted to pivot on the other end of the bottom and positioned generally perpendicular to the bottom, to form a partially folded frame, and a grill casing, wherein the partially folded frame unit encloses the grill casing on two adjacent perpendicular surfaces, wherein the casing has four bottom corners, and wherein each of the four bottom corners includes a pre-mounted fastening element adapted to engage a pre-mounted mating fastening element on each of the four top corners on top of the frame.

The fastening element on the grill casing comprises a first type of element comprising a plate which defines a slotted opening, and wherein the mating fastening element on the top of the frame unit comprises a first type of mating fastening element comprising a stud adapted to be received in the slotted opening. The fastening element on the grill casing comprises a second type of fastening element comprising a latch and wherein the mating fastening element on the top of the frame unit comprises a second type of mating fastening element comprising a hook. Two of the first type of fastening elements and mating fastening elements are provided on the front corners of the casing and stand. Two of the second type of fastening elements and mating fastening elements are provided on the back corners of the casing and stand.

The invention provides a partially assembled grill comprising a frame unit having a bottom and two sides, one side mounted to pivot on one end of the bottom so that it is folded against the bottom, and the other side mounted to pivot on the other end of the bottom and positioned generally perpendicular to the bottom, to form a partially folded frame, and a grill casing, wherein the partially folded frame unit encloses the grill casing on two adjacent perpendicular surfaces, wherein the casing has four bottom corners, and wherein each of the four bottom corners includes a pre-mounted fastening element adapted to engage a pre-mounted mating fastening element on each of the four top corners on top of the frame, wherein the fastening element on the grill casing comprises a first type of element comprising a plate which defines a slotted opening and wherein the mating fastening element on the top of the frame unit comprises a first type of mating fastening element comprising a stud adapted to be received in the slotted opening, and a second type of fastening element comprising a latch and wherein the mating fastening element on the top of the frame unit comprises a second type of mating fastening element comprising a hook.

Two of the first type of fastening elements and mating fastening elements are provided on the front corners of the casing and stand. Two of the second type of fastening elements and mating fastening elements are provided on the back corners of the casing and stand.

The invention provides a partially assembled grill comprising a frame unit having a bottom and two sides, one side mounted to pivot on one end of the bottom so that it is folded against the bottom, and the other side mounted to pivot on the other end of the bottom and positioned generally perpendicular to the bottom, to form a partially folded frame, and a grill casing, wherein the partially folded frame unit encloses the grill casing on two adjacent perpendicular surfaces, wherein the casing has four bottom corners, and wherein each of the four bottom corners includes a pre-mounted fastening element adapted to engage a pre-mounted mating fastening element on each of the four top corners on top of the frame, wherein the fastening element on the grill casing comprises a first type of element comprising a plate which defines a slotted opening and wherein the mating fastening element on the top of the frame unit comprises a first type of mating fastening element comprising a stud adapted to be received in the slotted opening, and a second type of fastening element comprising a latch and wherein the mating fastening element on the top of the frame unit comprises a second type of mating fastening element comprising a hook, wherein two of the first type of fastening elements and mating fastening elements are provided on the front corners of the casing and stand, and wherein two of the second type of fastening elements and mating fastening elements are provided on the back corners of the casing and stand.

The invention provides a method of packaging a partially assembled grill comprising locating a frame unit having a bottom and two sides, so that one side mounted to pivot on one end of the bottom so that it is folded against the bottom, and the other side is mounted to pivot on the other end of the bottom and positioned generally perpendicular to the bottom, to form a partially folded frame, and locating a grill casing so that the partially folded frame unit encloses the grill casing on two adjacent perpendicular surfaces.

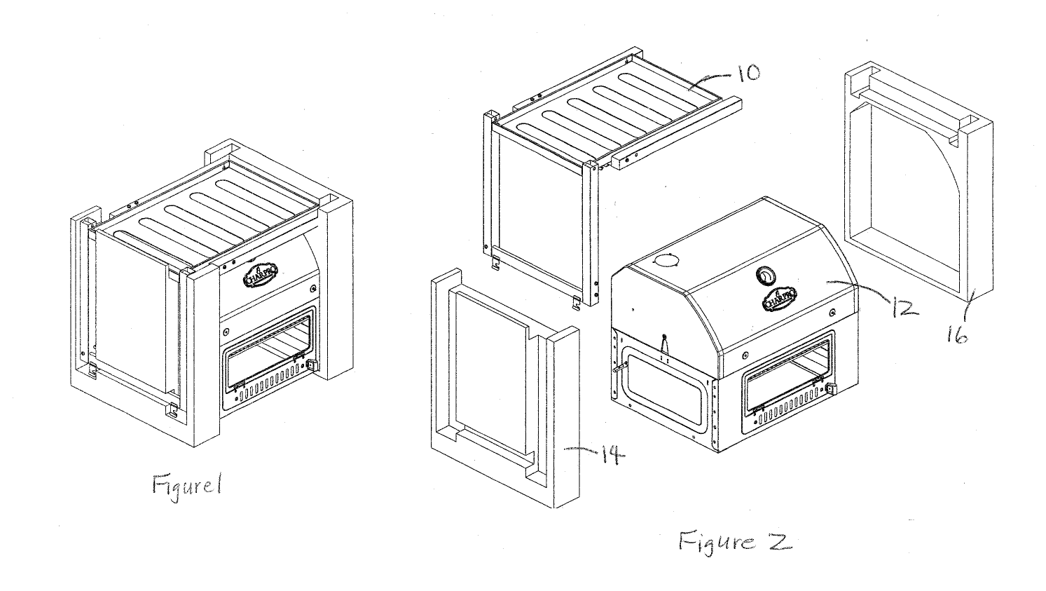

FIG. 1 shows the preassembled grill in its shipped state, removed from a box or container. FIG. 2 is an exploded view of FIG. 1, showing a stand 10, a firebox casing 12, and two shipping inserts 14 and 16, which may be made of foam, polystyrene, cardboard or the like.

The stand 10 has three major parts, which are a bottom 20, a first side 22 and another second side 24. The side 22, which is positioned perpendicular to the bottom 20 fits on the outer, left side of the insert 14 when shipped, while the second side 24 is folded generally flat against the bottom 22 in FIGS. 1 and 2.

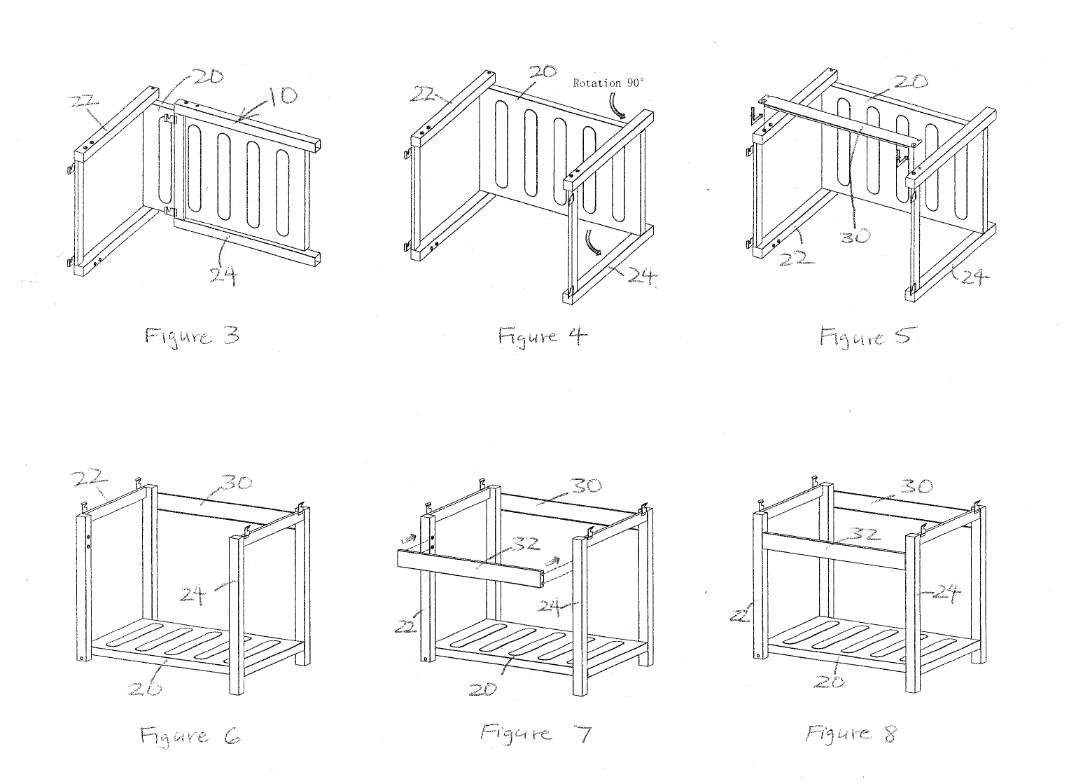

FIG. 3 shows the stand 10 alone in the same configurations as FIGS. 1 and 2. In FIG. 4, the second side 24 has been unfolded to be perpendicular to the bottom 20, similar to the first side 22. In FIG. 5, a first side bar 30 is being attached to join the first and second sides 22 and 24. In FIG. 5, the side bar is first placed in contact with both first and second sides 22 and 24, and then slid along into final position, and indicated by the arrows. Appropriate fasteners can secure the side bar its final position. The fasteners can be located already in the fastening holes and then tightened so that the consumer does not have to find and insert them into the first and second sides 22 and 24.

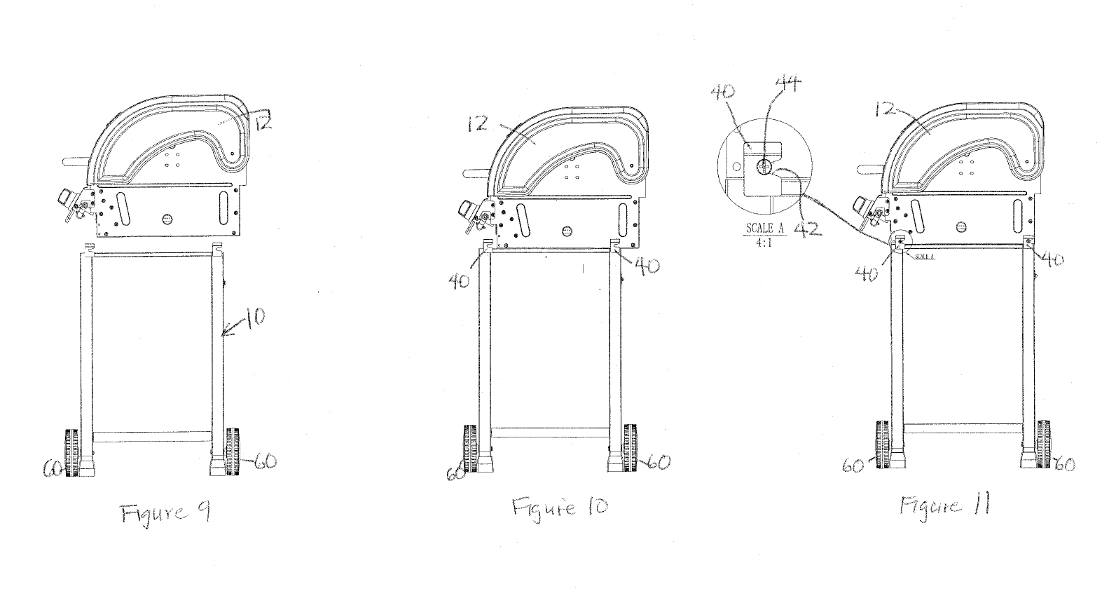

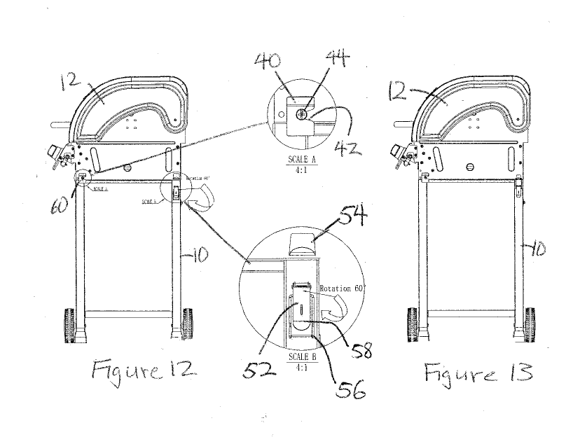

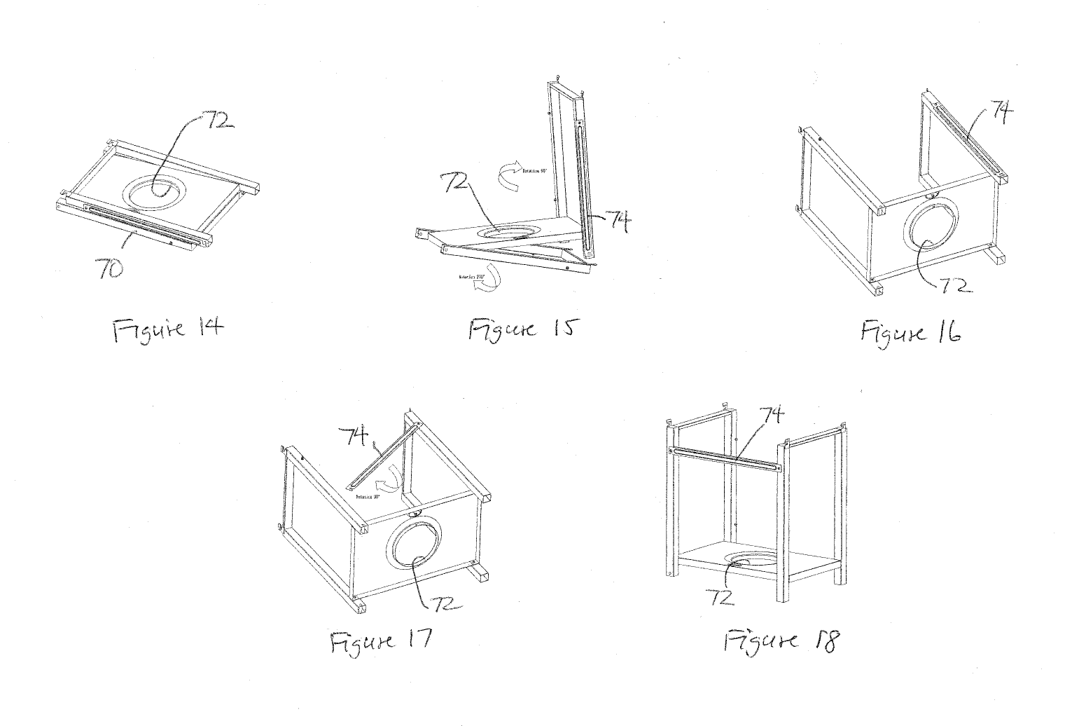

FIG. 6 shows the stand in an upright position with one side bar 30 attached, and FIG. 7 shows the other side bar 32 being placed into position. FIG. 8 shows the other side bar fastened into position.

FIG. 9 shows a side view of the stand with the firebox casing 12 in contact with the stand 10, but not yet in its final assembly position. After the firebox casing is in the position shows in FIG. 10, it is slid to the left to the final assembly position shown in FIG. 11. A partial blow up of FIG. 11 shows a first type of connector 40 on the stand having a side slot 42 which receives stud 44 on the firebox casing 12. In FIGS. 9-11, each of the four corners of the stand and firebox casing has the same first type of connector 40 and stud 44.

Although FIG. 11 shows the firebox casing 12 in its final assembly position, the firebox casing 12 is not yet fully attached to the stand 10. FIG. 12 shows a second type of connector in the form of a latch mechanism 50 comprising a latch 52 on the stand 10 and a hook 54 on the firebox casing 12. The opposite side of the stand 10 and the firebox casing 12 have a similar latch mechanism. FIG. 12 shoes the latch mechanism fully engaged, which keeps the firebox casing 12 secure on top of the stand 10. In this position, the loop 56 on the lever 58 of the latch 52 engages the hook 54. FIGS. 9-11 also show wheels 60 mounted to the lower ends of a stand side.

FIGS. 14-18 show an alternative arrangement for a stand, in which the bottom 70 has a ring 72 for receiving and holding a propane tank, and wherein at least one of the side bars 74 has one of its ends pre-mounted to one side of the stand during shipment, and the other end of the side bar has a slot to engage a fastener at stud on the other side of the stand, thereby avoiding having a loose side bar, and loose fasteners, during shipment. Having pre-mounted components including fasteners makes the assembly quicker and easier, and avoids having to find, match, and assemble loose parts.

Although a preferred embodiment has been described, the present invention is not limited to the embodiment illustrated. The scope of the invention is limited only by the following claims.

What is claimed is:

1. A partially assembled grill comprising:
a frame unit having a bottom and two sides, one side mounted to pivot on one end of the bottom so that it is folded against the bottom, and the other side mounted to pivot on the other end of the bottom and positioned generally perpendicular to the bottom, to form a partially folded frame; and
a grill casing, wherein the partially folded frame unit encloses the grill casing on two adjacent perpendicular surfaces.

2. The grill unit according to claim 1, wherein the frame unit comprises at least one side bar to connect the ends of the two sides away from the bottom.

3. The grill unit according to claim 2, wherein the frame of the side bar is connected at one of its ends to an end of one of the sides.

4. The grill unit according to claim 1, wherein the grill casing includes at least one fastening element pre-mounted to one of its bottom corners adapted to engage a pre-mounted fastening element on the top of the frame unit.

5. The grill unit according to claim 4, wherein the casing has four bottom corners, and wherein each of the four bottom corners includes a pre-mounted fastening element adapted to engage a pre-mounted mating fastening element on each of the four top corners on top of the frame.

6. The grill unit according to claim 4, wherein the fastening element on the grill casing comprises a first type of element comprising a plate which defines a slotted opening, and wherein the mating fastening element on the top of the frame unit comprises a first type of mating fastening element comprising a stud adapted to be received in the slotted opening.

7. The grill unit according to claim 4, wherein the fastening element on the grill casing comprises a second type of fastening element comprising a latch and wherein the mating fastening element on the top of the frame unit comprises a second type of mating fastening element comprising a hook.

8. The grill unit according to claim 6, wherein two of the first type of fastening elements and mating fastening elements are provided on the front corners of the casing and stand.

9. The grill unit according to claim 7, wherein two of the second type of fastening elements and mating fastening elements are provided on the back corners of the casing and stand.

10. A partially assembled grill comprising:
a frame unit having a bottom and two sides, one side mounted to pivot on one end of the bottom so that it is folded against the bottom, and the other side mounted to pivot on the other end of the bottom and positioned generally perpendicular to the bottom, to form a partially folded frame; and
a grill casing, wherein the partially folded frame unit encloses the grill casing on two adjacent perpendicular surfaces, wherein the casing has four bottom corners, and wherein each of the four bottom corners includes a pre-mounted fastening element adapted to engage a pre-mounted mating fastening element on each of the four top corners on top of the frame.

11. The grill unit according to claim 10, wherein the fastening element on the grill casing comprises a first type of element comprising a plate which defines a slotted opening, and wherein the mating fastening element on the top of the frame unit comprises a first type of mating fastening element comprising a stud adapted to be received in the slotted opening.

12. The grill unit according to claim 10, wherein the fastening element on the grill casing comprises a second type of fastening element comprising a latch and wherein the mating fastening element on the top of the frame unit comprises a second type of mating fastening element comprising a hook.

13. The grill unit according to claim 11, wherein two of the first type of fastening elements and mating fastening elements are provided on the front corners of the casing and stand.

14. The grill unit according to claim 12, wherein two of the second type of fastening elements and mating fastening elements are provided on the back corners of the casing and stand.

15. A partially assembled grill comprising:
a frame unit having a bottom and two sides, one side mounted to pivot on one end of the bottom so that it is folded against the bottom, and the other side mounted to pivot on the other end of the bottom and positioned generally perpendicular to the bottom, to form a partially folded frame; and
a grill casing, wherein the partially folded frame unit encloses the grill casing on two adjacent perpendicular surfaces, wherein the casing has four bottom corners, and wherein each of the four bottom corners includes a pre-mounted fastening element adapted to engage a pre-mounted mating fastening element on each of the four top corners on top of the frame, wherein the fastening element on the grill casing comprises a first type of element comprising a plate which defines a slotted opening and wherein the mating fastening element on the top of the frame unit comprises a first type of mating fastening element comprising a stud adapted to be received in the slotted opening, and a second type of fastening element comprising a latch and wherein the mating fastening element on the top of the frame unit comprises a second type of mating fastening element comprising a hook.

16. The grill unit according to claim 15, wherein two of the first type of fastening elements and mating fastening elements are provided on the front corners of the casing and

17. The grill unit according to claim 12, wherein two of the second type of fastening elements and mating fastening elements are provided on the back corners of the casing and stand.

18. A partially assembled grill comprising:
a frame unit having a bottom and two sides, one side mounted to pivot on one end of the bottom so that it is folded against the bottom, and the other side mounted to pivot on the other end of the bottom and positioned generally perpendicular to the bottom, to form a partially folded frame; and
a grill casing, wherein the partially folded frame unit encloses the grill casing on two adjacent perpendicular surfaces, wherein the casing has four bottom corners, and wherein each of the four bottom corners includes a pre-mounted fastening element adapted to engage a pre-mounted mating fastening element on each of the four top corners on top of the frame, wherein the fastening element on the grill casing comprises a first type of element comprising a plate which defines a slotted opening and wherein the mating fastening element on the top of the frame unit comprises a first type of mating fastening element comprising a stud adapted to be received in the slotted opening, and a second type of fastening element comprising a latch and wherein the mating fastening element on the top of the frame unit comprises a second type of mating fastening element comprising a hook, wherein two of the first type of fastening elements and mating fastening elements are provided on the front corners of the casing and stand, and wherein two of the second type of fastening elements and mating fastening elements are provided on the back corners of the casing and stand.

19. A method of packaging a partially assembled grill comprising:
locating a frame unit having a bottom and two sides, so that one side is mounted to pivot on one end of the bottom so that it is folded against the bottom, and the other side is mounted to pivot on the other end of the bottom and positioned generally perpendicular to the bottom, to form a partially folded frame; and
locating a grill casing so that the partially folded frame unit encloses the grill casing on two adjacent perpendicular surfaces.
